(19) United States
(12) Patent Application Publication
(10) Pub. No.: US 2009/0325682 A1
(43) Pub. Date: Dec. 31, 2009

(54) GAMING SYSTEM HAVING COMPOSITE AWARDS

(75) Inventors: Christopher R. Barney, Las Vegas, NV (US); Alfred Thomas, Las Vegas, NV (US)

Correspondence Address: NIXON PEABODY LLP, 300 S. Riverside Plaza, 16th Floor, CHICAGO, IL, 60606, US

(73) Assignee: WMS Gaming Inc., Waukegan, IL (US)

(21) Appl. No.: 12/513,790

(22) PCT Filed: Oct. 19, 2007
(86) PCT No.: PCT/US2007/022290

§ 371 Date: May 6, 2009

Related U.S. Application Data
(60) Provisional application No. 60/857,435, filed on Nov. 7, 2006.

(51) Int. Cl. A63F 9/24; A63F 13/00

(52) U.S. Cl. 463/20; 463/30

(57) ABSTRACT

A gaming system comprises a wager input device and a display for displaying a first randomly selected outcome of a first wagering game. The first randomly selected outcome is selected from a first plurality of possible outcomes. The first plurality of possible outcomes includes a first winning outcome. The gaming system further comprises a controller operative to provide a first award to the player when the first randomly selected outcome is the first winning outcome. The first award comprises a fixed portion and a variable portion, the fixed portion having a predetermined value, the variable portion having an expected value for which the actual value is determined at least in part by a second randomly selected outcome of a second wagering game, wherein the second wagering game is triggered independently of the first wagering game.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a handheld gaming system having dynamically adjusting interfaces and displays.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming systems with new types of bonus games to satisfy the demands of players and operators.

Traditionally, gaming machines provide players with awards and prizes having fixed credit values. Bonus games provide additional enjoyment and entertainment, but ultimately still provide players with fixed credit value awards upon conclusion. One problem with such an award scheme is that the player's incentive to continue playing the gaming machine is limited to the inherent entertainment value therein. Another problem is that insufficient mechanisms are provided by which awards to players, or portions thereof, are delayed, extended, or entered into one or more subsequent wagering games. Yet another problem that exists is that such fixed awards are limited in size and amount whereas delayed awards may be provided in larger, more exciting amounts. The present invention is directed to solving these and other problems.

### SUMMARY OF THE INVENTION

According to one aspect of the present invention, a gaming system for conducting a wagering game comprises a wager input device and a display for displaying a first randomly selected outcome of a first wagering game. The first randomly selected outcome is selected from a first plurality of possible outcomes, the first plurality of possible outcomes including a first winning outcome. The gaming system further comprises a controller operative to provide a first award to the player when the first randomly selected outcome is the first winning outcome. The first award comprises a fixed portion and a variable portion, the fixed portion having a predetermined value, the variable portion having an expected value for which the actual value is determined at least in part by a second randomly selected outcome of a second wagering game, wherein the second wagering game is triggered independently of the first wagering game.

According to another aspect of the invention, a method of conducting a wagering game on a gaming system comprises receiving a wager from a player and displaying a first randomly selected outcome of a first wagering game, the first randomly selected outcome selected from a first plurality of possible outcomes, the first plurality of possible outcomes including a first winning outcome. The method further comprises, in response to the first randomly selected outcome being the first winning outcome, awarding a first award to the player, the first award comprising a fixed portion and a variable portion, the fixed portion having a predetermined value, the variable portion having an expected value and comprising a wager input on a second wagering game. The method further comprises wagering the variable portion on a second randomly selected outcome of the second wagering game. The method further comprises triggering the second wagering game independently of the first wagering game, and determining an actual value of the variable portion of the first award based at least in part upon the second randomly selected outcome.

According to yet another aspect of the invention, a method of conducting a wagering game on a gaming system comprises receiving a wager from a player and displaying a randomly selected outcome of the wagering game, the randomly selected outcome selected from a plurality of possible outcomes, the plurality of possible outcomes including a plurality of winning outcomes. The method further comprises, in response to the randomly selected outcome being a first winning outcome, providing a first predetermined credit award to the player. The method further comprises, in response to the randomly selected outcome being a second winning outcome, providing a composite award to the player, the composite award comprising a second predetermined credit award and a variable award, the variable award represented by a predetermined number of bonus credits, the variable award having an expected value and an actual value, wherein the actual value is determined by wagering the bonus credits in an independently conducted second wagering game.

According to yet another aspect of the invention, a computer readable storage medium is encoded with instructions for directing a gaming system to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free standing gaming machine embodying the present invention;

FIG. 1b is a perspective view of a handheld gaming machine embodying the present invention;

FIG. 2 is a block diagram of a control system suitable for operating the gaming machines of FIGS. 1a and 1b;

FIG. 3 is a front view of the primary display of a gaming system providing composite awards displaying a screen shot of a first wagering game;

FIG. 4 is an exemplary pay table of the gaming system of FIG. 3;

FIG. 5 is a screen shot of another play of the first wagering game of FIG. 3;

FIG. 6 is a screen shot of yet another play of the first wagering game of FIG. 3;

FIG. 7 is a screen shot of a player initiating entry of selections in a second wagering game;

FIG. 8 is a screen shot of a player inputting selections in a second wagering game of the gaming system of FIG. 3;

FIG. 9 is a screen shot of an outcome of the second wagering game of FIG. 8; and

FIG. 10 is an exemplary pay table of the second wagering game of FIG. 8.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

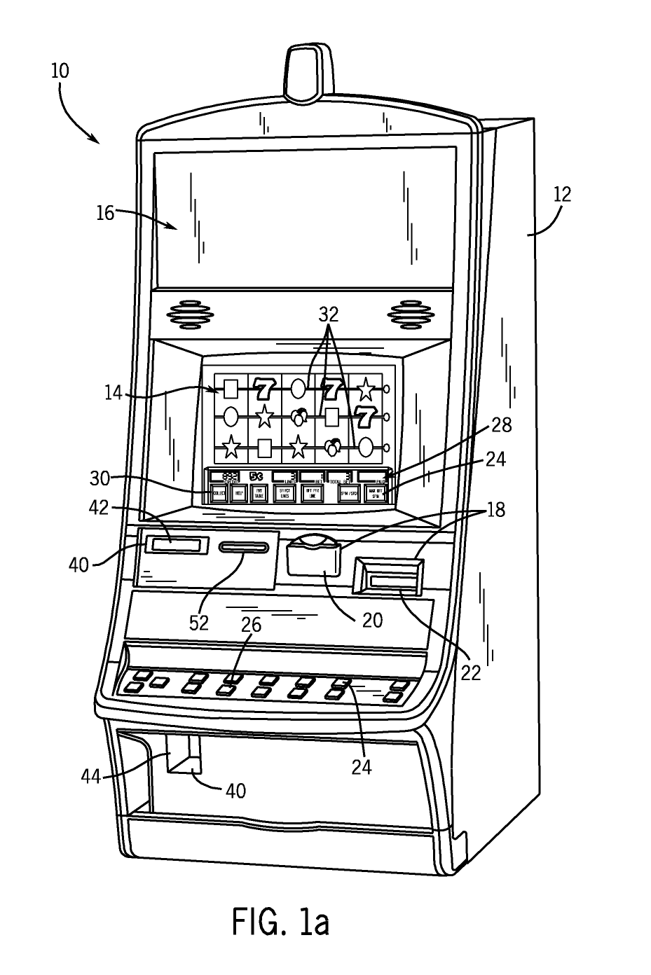

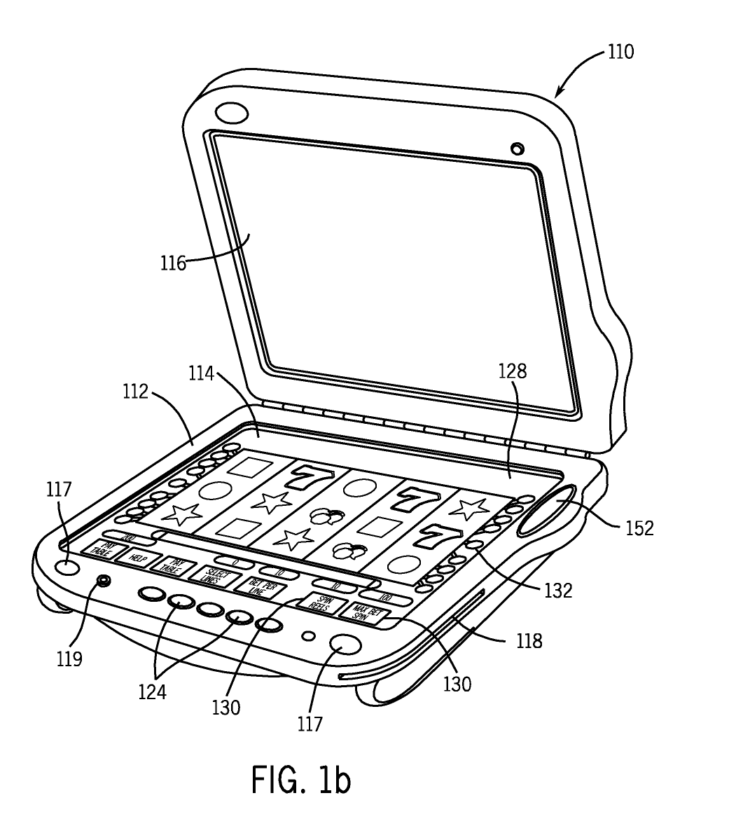

Referring to FIG. 1a, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as blackjack, slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, blackjack, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g., an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons on a button panel for operating the handheld gaming machine 110. In addition, or alternatively, the player input device 124 may comprise a touch screen mounted to a primary display 114 and/or secondary display 116. In one aspect, the touch screen is matched to a display screen having one or more selectable touch keys 130 selectable by a user's touching of the associated area of the screen using a finger or a tool, such as a stylus pointer. A player enables a desired function either by touching the touch screen at an appropriate touch key 130 or by pressing an appropriate push button 126 on the button panel. The touch keys 130 may be used to implement the same functions as push buttons 126. Alternatively, the push buttons may provide inputs for one aspect of the operating the game, while the touch keys 130 may allow for input needed for another aspect of the game. The various components of the handheld gaming machine 110 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences.

The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3″ display to a 15″ or 17″ display. In at least some aspects, the primary display 114 is a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 110. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver or computer readable storage medium interface. In one presently preferred aspect, the player information reader 152, shown by way of example in FIG. 1b, comprises a biometric sensing device.

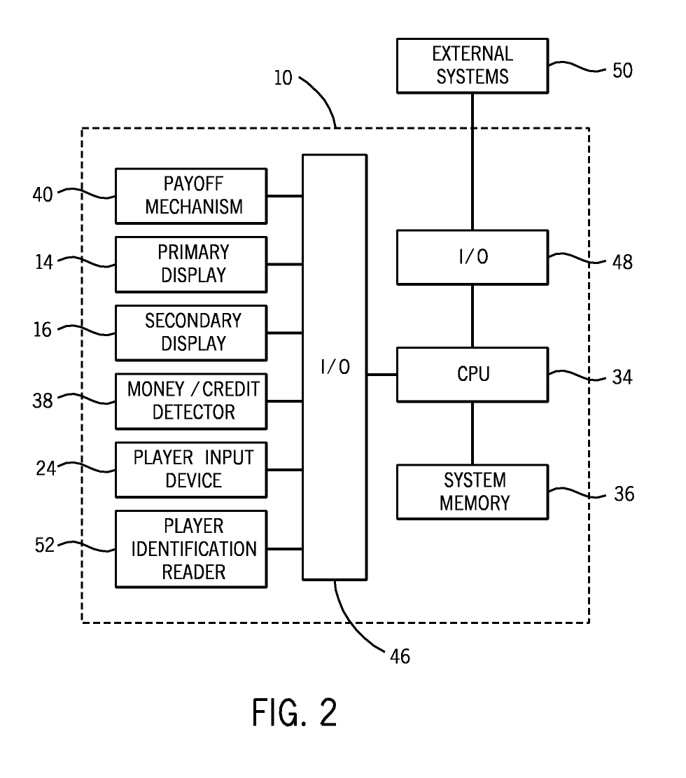

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1a, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36. The controller 34 may reside partially or entirely inside or outside of the machine 10. The control system for a handheld gaming machine 110 may be similar to the control system for the free standing gaming machine 10 except that the functionality of the respective on-board controllers may vary.

The gaming machines 10,110 may communicate with external systems 50 (in a wired or wireless manner) such that each machine operates as a “thin client,” having relatively less functionality, a “thick client,” having relatively more functionality, or through any range of functionality there between. As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “thicker client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10,110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

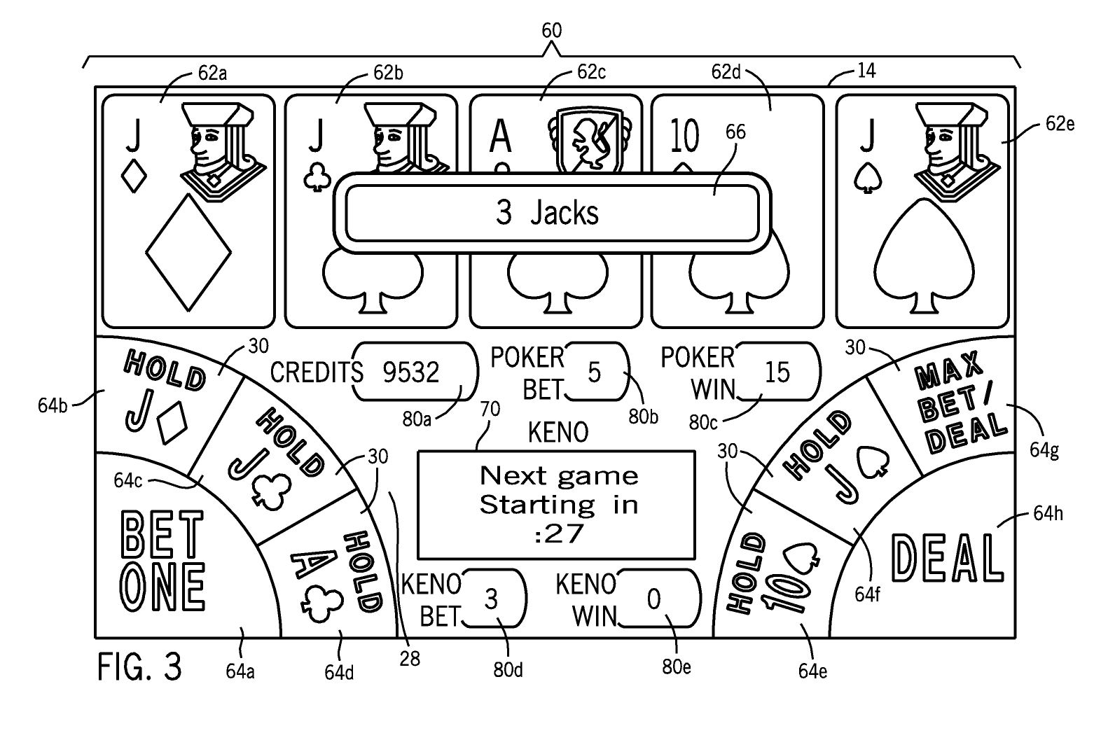

Turning now to FIG. 3, the primary display 14 of a wagering game according to the present invention is shown. The wagering game may be displayed on the display 14 of a free standing gaming machine 10 as shown in FIGS. 1a and 3, or on the display 114 of a handheld gaming machine 110 as seen in FIG. 1b. The display 14 of the wagering game in FIG. 3 includes a first wagering game 60, which in this embodiment is a poker game. The display 14 also displays a second wagering game 70, which in this embodiment is a keno game. The keno game 70 is positioned on the lower center portion of the primary display 14, and is shown in a non-active or minimized state. In alternative embodiments, the first and second wagering games 60,70 may be any number of different wagering games, as described with relation to FIGS. 1-2 herein.

The poker game 60 includes a plurality of cards 62a,b,c,d,e positioned along the top of the primary display 14 for displaying the poker game. The display 14 further includes a plurality of input selections 64 with which a player provides selection inputs to control the poker game. In this embodiment, the input selections 64 include a BET button 64a, five HOLD buttons 64b,c,d,e,f corresponding to the five cards 62a,b,c,d,e used in the poker game, a MAX BET button 64g for inputting a wager which is the maximum wager allowed on the gaming machine 10, and a DEAL/DRAW button 64h for commencing the deal of a new poker hand or drawing replacement cards 62 for the poker hand. In some embodiments, as seen in FIG. 3, some of the input selections 64 may include additional information. For example, the five HOLD buttons 64b-f, in addition to the word “HOLD”, may also include indicia of the cards 62 to which the selections 64b-f correspond. Thus, in FIG. 3, each of the HOLD buttons 64b-f includes an image of the rank and suit of the card 62a,b,c,d,e to which it corresponds (e.g. jack of diamonds, jack of clubs, ace of clubs, ten of spades and jack of spades). In this embodiment, the input selections 64 are actuated via a touch screen 28 overlying the display 14 which includes soft keys 30 corresponding to each of the input selections 64 available to the player. In other embodiments, however, the input selections 64 may be received through a variety of player input devices as described herein with reference to FIGS. 1-2.

The display 14 also includes a plurality of information fields 80 which provide information relating to the first and second wagering games 60,70. The information fields 80 include a credit meter 80a, a poker bet meter 80b, and a poker win meter 80c, relevant to the poker game 60. The information fields 80 also include a keno bet meter 80d and a keno win meter 80e relevant to the keno game 70. These information fields 80 provide information to the player via the primary display 14 related to the status of present and past wagering games 60,70 played on the gaming machine 10. The information fields 80 may further include labels for identifying the fields 80 as seen in FIG. 3.

In FIG. 3, the conclusion of one hand of the poker game 60 is displayed on the display 14. The resultant hand is a winning outcome which is a “three of a kind” winning outcome. More specifically, the winning outcome is a “three jacks” winning outcome, which is communicated to the player via an outcome label 66 overlying the cards 62 of the poker game 60. In this embodiment, the outcome label 66 involves text displaying the words “3 Jacks” to the player, but in alternative embodiments, the outcome label 66 may take on many forms which communicate the nature of the winning outcome on the primary display 14, including highlighting the winning cards 62 in the hand of the poker game 60.

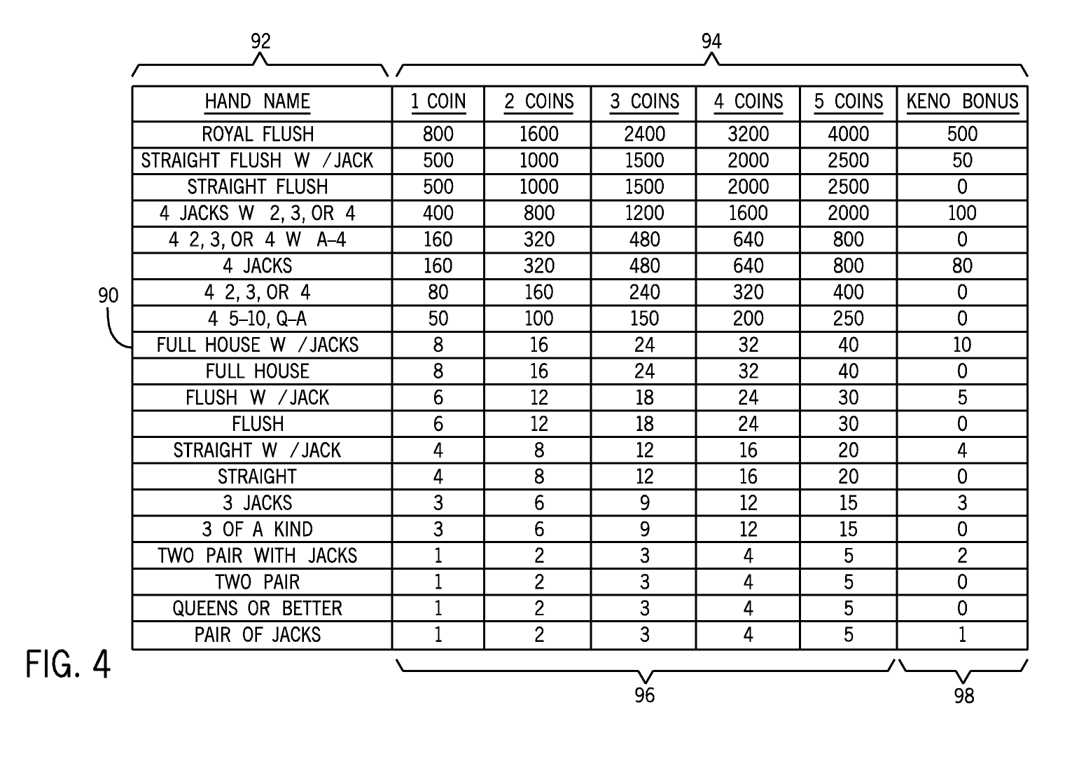

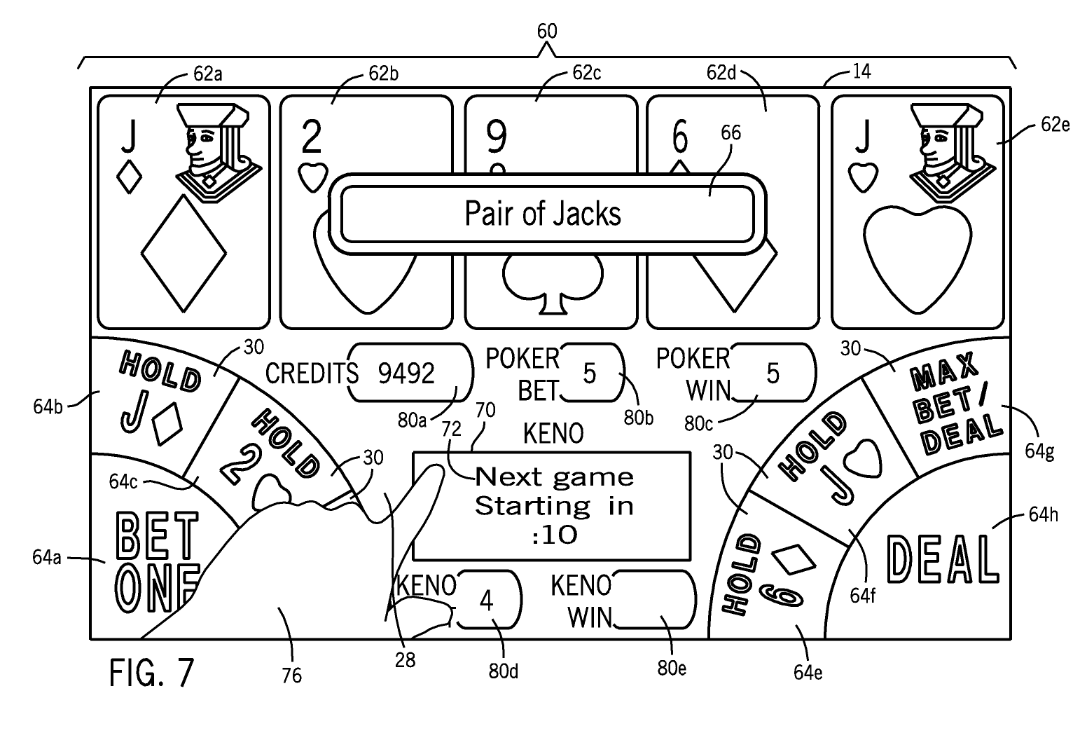

The player had wagered 5 credits on this play of the poker game 60, as seen on the poker bet meter 80b in FIG. 3. Because the hand has resulted in a winning outcome (three jacks), the player is provided an award in accordance with a pay table of the first wagering game 60 (see pay table in FIG. 4). As seen in FIG. 3, the award for the three jacks winning outcome comprises a first portion and a second portion. The first portion is an award of 15 credits, as seen in the poker win meter 80c. The second portion of the award is a Keno Bonus award of 3 bonus credits as seen in the keno bet meter 80d. In this embodiment, the first portion is a fixed amount comprising a predetermined credit value of 15 credits. The second portion, however, is of a variable value represented by a Keno Bonus award of 3 bonus credits. Unlike the first portion of the award, the variable award is not immediately redeemable by the player. Rather, the variable award comprises a bonus credit amount which the player wagers in the second wagering game 70, as described herein with reference to FIGS. 7-10. The variable award of 3 bonus credits in FIG. 3 has an expected value associated with it at the time that it is awarded. However, the actual value of the variable award is not determined until a play of the second wagering game 70 is completed. Thus, the variable award of 3 bonus credits constitutes a second wager (of bonus credits) that the player may make in the second wagering game 70. In this way, the award provided in FIG. 3 for the three jacks winning outcome is a composite award made up of a fixed value award and a variable award.

The variable award of 3 bonus credits is banked in the keno bet meter 80d for future play in the second wagering game 70 (the keno game). In FIG. 3, the display 14 indicates to the player that the keno game 70 will be commencing in twenty-seven seconds, by presenting to the player a keno status 72. Thus, the player may continue to play the poker game 60 until such time that the keno game 70 begins. In this embodiment, the keno game 70 is executed on a time-based trigger, as seen in the keno status 72. Therefore, the keno game 70 is triggered independently of the poker game 60. In alternative embodiments, the keno game 70 may be triggered independently of the poker game 60 in other ways, such as by a mystery trigger or randomly initiated.

In FIG. 4, a pay table 90 for the first wagering game 60 (the poker game) is displayed. The pay table 90 includes a plurality of winning outcomes 92 of the poker game 60 which are listed by the name of the hands constituting the winning outcome 92. The pay table 90 also includes a plurality of awards 94 associated with the winning outcomes 92. The awards 94 include credit awards 96 and keno bonus awards 98. In this embodiment, all of the winning outcomes 94 included in the pay table 90 receive credit awards 96. The credit awards 96 associated with each winning outcome 92 of the poker game 60 are dependent upon the number of coins wagered, as shown across the top row of the pay table 90. Thus, as the number of credits or coins wagered increases, the credit award 96 for a particular winning outcome 92 increases as well. Moreover, certain selected winning outcomes 94 in the pay table 90 also receive an additional award in the form of a keno bonus award 98. For example, in the pay table 90 in FIG. 4, for a player wagering 5 coins, a three of a kind winning outcome 92 receives a credit award 96 of 15 credits, but no keno bonus award 98. However, a three jacks winning outcome 92 receives a credit award 96 of 15 credits, plus a keno bonus award 98 of 3 bonus credits. Thus, in the embodiment shown, the selected winning outcomes 92 for which keno bonus awards 98 are awarded are poker hands which include one or more Jacks in the winning outcome 92. Thus, for the selected winning outcomes 92, a jack must be included in, and necessary to complete the winning outcome 92. Therefore, according to the pay table 90 in FIG. 4, the selected winning outcomes for which keno bonus awards 98 are paid in addition to credit awards 96 include: a pair of jacks; two pair with jacks (two pair where one of the pairs is a pair of jacks); three jacks; a straight with a jack; a flush with a jack; a full house with jacks; four jacks; four jacks with a 2, 3, or 4; a straight flush with a jack; and a royal flush. The remaining winning outcomes 92 in the pay table 90 receive only credit awards 96. As described with reference to FIG. 3, the three jacks outcome 92 obtained by the player was awarded with 15 credits and 3 bonus bet credits, in accordance with the paytable 90 of FIG. 4.

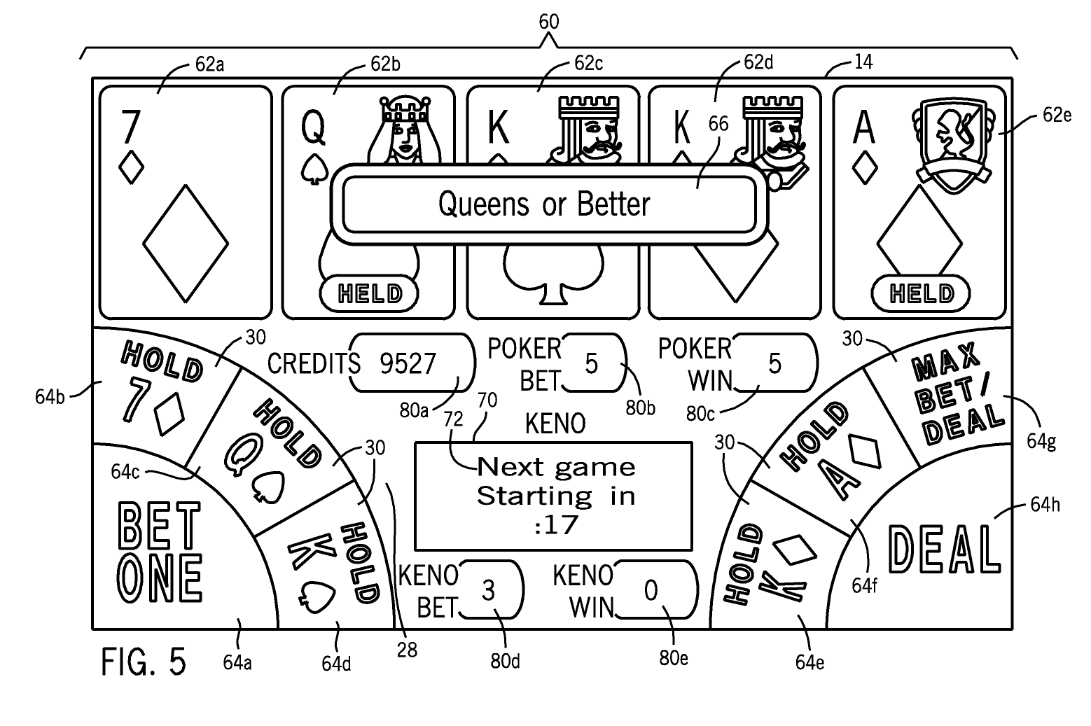

In FIG. 5, another play of the poker game 60 is shown on the primary display 14. The game 60 has concluded and the resultant hand is a pair of kings, which is a winning outcome. Thus, the game 60 has resulted in a winning outcome which is a “Queens or Better” winning outcome, as shown by the outcome label 66 on the display 14. Therefore, in accordance with the pay table 90, the player has been provided a credit award 96 of five credits, as shown by the poker win meter 80c. Because the winning outcome did not include a jack, it is not one of the selected winning outcomes for which a keno bonus award 98 is awarded. Therefore, the keno bet meter 80d is unchanged and continues to show the previous balance of three keno bet bonus credits. The keno game 70 has not yet begun as is indicated by the keno status 72 that the keno game 70 will be starting in seventeen seconds.

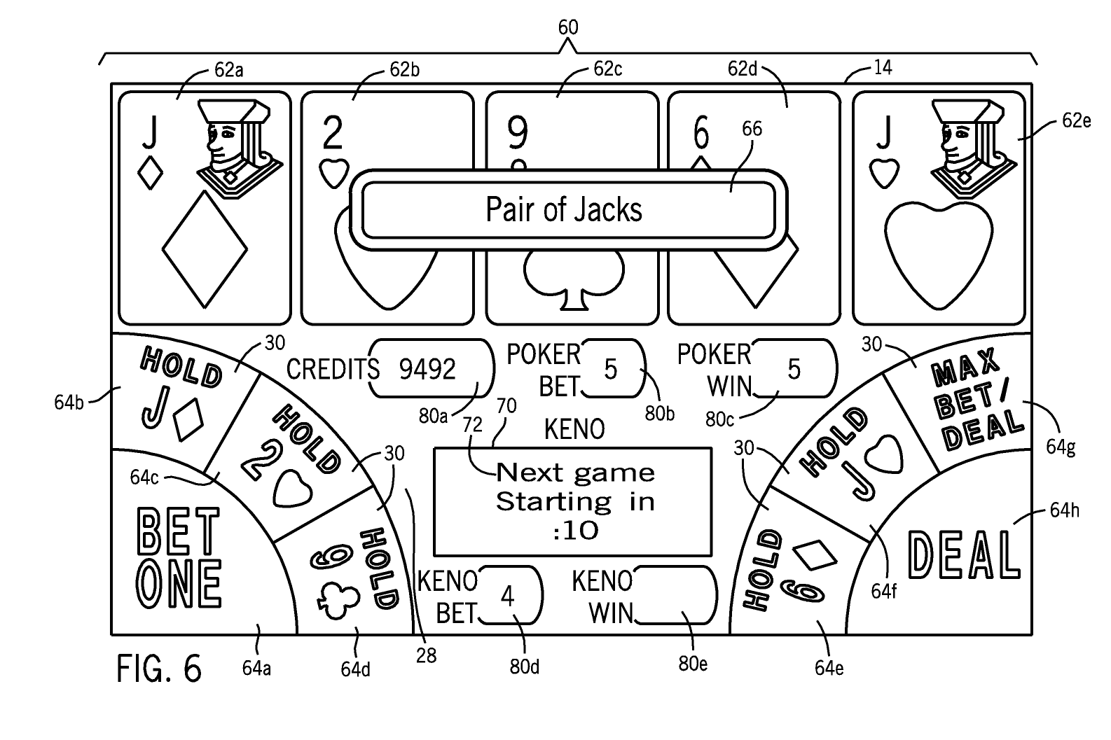

In FIG. 6, yet another play of the poker game 60 is shown on the primary display 14. Again the game 60 is shown at its conclusion, where in this instance the result of the game 60 is again a winning outcome. On this play of the game 60, the resultant hand is a pair of jacks winning outcome, as shown by the outcome label 66 on the display 14. In accordance with the pay table 90, the player is provided a composite award of a credit award 96 and a keno bonus award 98 because the winning outcome is a selected winning outcome including at least one jack. Thus, according to the pay table 90, the player receives a fixed credit award of five credits (as seen in the poker win meter 80c) as well as a variable award of 1 keno bonus credit (as seen in the incrementing of the keno bet meter 80d from three to four keno bonus credits). Moreover, as seen in FIG. 6, the keno game 70 has not yet started, as shown by the keno status 72 on the display 14 which reflects that the commencement of the keno game 70 will be in ten seconds.

In FIG. 7, prior to the commencement of the keno game 70, the player 76 is provided with an opportunity to input player selections of his desired keno numbers for entry into the game 70. In this embodiment, the player 76 may input his keno selections at any time prior to the commencement of the keno game 70. To do so, the player 76 touches the minimized keno game 70 icon on the lower center portion of the display 14, as seen in FIG. 7. The gaming machine 10 may provide the player 76 with discreet times during which such player selections may be input, or may continually allow such player selections to be input at any time by the player 76.

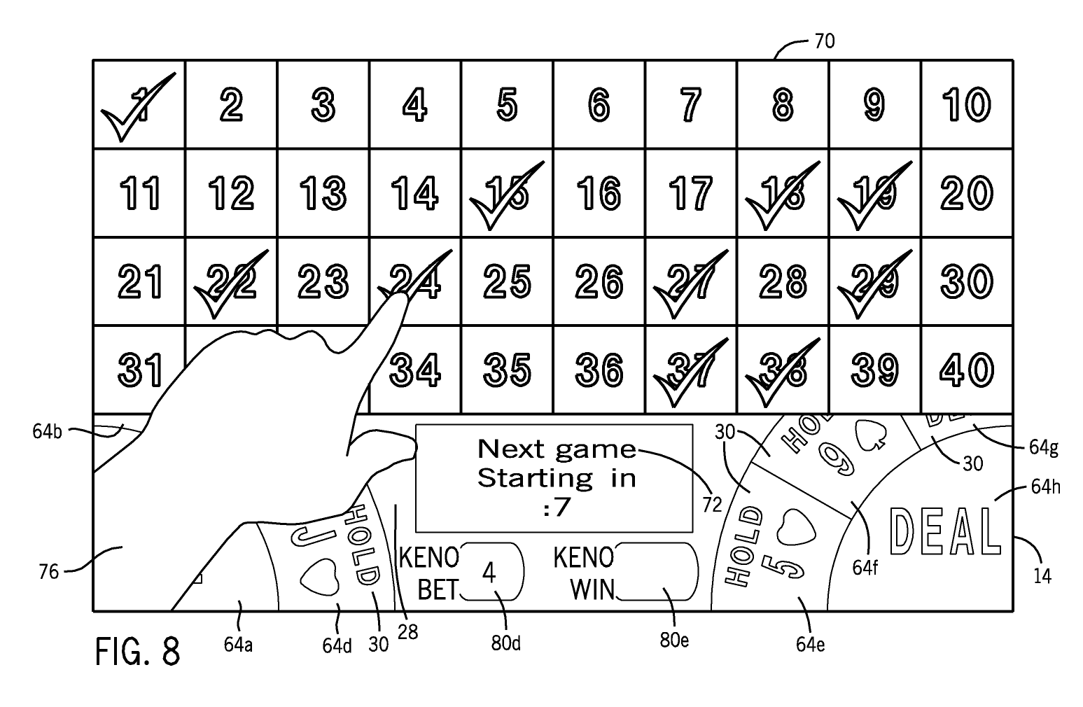

Once the icon is touched by the player 76, the keno game 70 is then expanded to overlay the poker game 60, as seen in FIG. 8. The poker game 60 is paused but still shown in the background of the display 14. The player 76 then proceeds to enter his selections of keno numbers from the keno board shown on the maximized keno game 70. In this embodiment of the keno game 70, the player 76 selects between four and ten out of the forty available keno numbers in the keno game 70. In this instance, the player 76 has selected ten numbers (the numbers 1, 15, 18, 19, 22, 24, 27, 29, 37 and 38). The player's selections are denoted with a check mark, as seen in FIG. 8. Also, the player 76 has completed his selections prior to the keno game 70 commencing as shown by the keno status 72 in FIG. 8, indicating that seven seconds remain prior to the commencement of the keno game 70. Moreover, the player's wager in the keno game 70 comprises the four keno bonus credits shown in the keno bet meter 80d which the player 76 had previously won and accrued. In this embodiment, the player 76 must wager all of the keno bonus credits accumulated on the next upcoming play of the keno game 70. In alternative embodiments, the player 76 may wager some, all, or none of his accrued keno bonus credits on the next upcoming keno game 70 and may bank or save any unused keno bonus credits for use in future keno games 70. In another alternative embodiment, the keno game 70 may include a “Quick Pick” input that causes the keno game 70 to randomly select numbers for the player instead of requiring the player to individually select each number. In yet another alternative embodiment, the keno game 70 may include an “Auto Pick” feature so that if the player 76 fails to enter his selections, the keno game 70 randomly selects numbers for the player. In this embodiment, the keno game 70 allows players to enter their selections up through such time that only seven seconds remain until the keno game begins 70. If the player has not entered all of his selections prior to that cutoff time, the keno game 70 employs an “Auto Pick” mechanism to automatically select a sufficient quantity of keno numbers for the game 70.

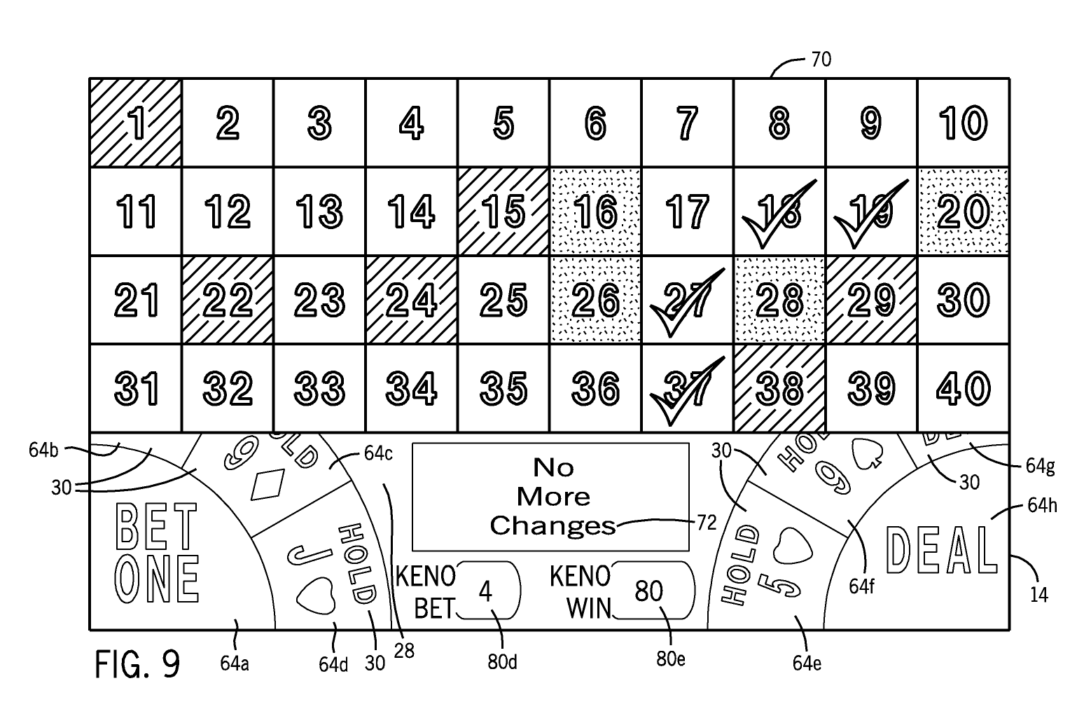

In FIG. 9, the display 14 shows the keno game 70 after the game 70 has been completed. In this embodiment, the processor of the gaming machine 10 generates a randomly selected outcome of the keno game 70 by selecting ten of the forty available numbers and then compares the machine-selected numbers against the player's selected numbers. In FIG. 9, the randomly selected outcome selected by the processor is shown as the numbers 1, 15, 16, 20, 22, 24, 26, 28, 29 and 38, each of which have a darkened, shaded, or hatched background. Thus when these numbers are compared against the player's selected numbers, six of the numbers “match”, or were selected by both the processor and the player 76 (numbers 1, 15, 22, 24, 29, and 38), and are denoted as a “match” by the diagonal hatched backgrounds therein. Numbers selected by the player 76 but not by the gaming machine 10 remain shown as checked.

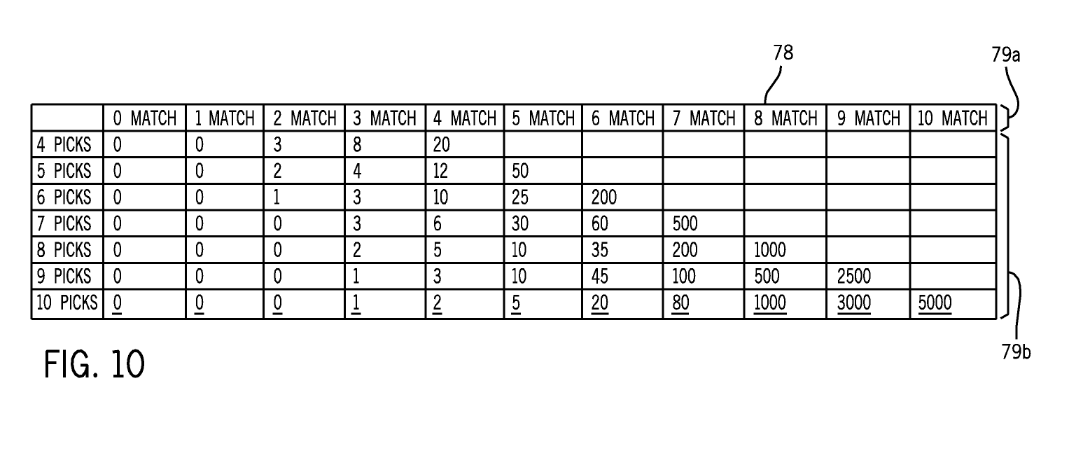

The keno game 70 then awards the player a keno award based upon the number of matching numbers. In this instance, the keno game 70 awards the player 80 credits which are shown in the keno win meter 80e in FIG. 9. The keno win award is a predetermined fixed value of credits based upon the number of matching numbers multiplied by the number of bonus credits wagered. Thus, the eighty credit award corresponds to the player having six matching numbers out of ten numbers selected (20 credits according to the keno pay table), multiplied by the number of bonus credits wagered (4 bonus credits wagered). The keno game 70 pays this keno win award in accordance to a second pay table 78 listing keno wins and corresponding credit awards (see FIG. 10). During play of the keno game 70, the keno status 72 indicates to the player that “No More Changes” to the player's selections are permitted. This signals the player 76 that no more inputs or selections are permitted and the keno game 70 is either running or concluded. Upon completion of the keno game 70, the display 14 returns to the poker game 60 for additional game play thereof (such as in FIG. 3, 5, or 6). The keno bet meter 80d is reset to zero (since the player's four keno bonus credits have already been wagered or “played” in FIG. 9). Credits in the keno win meter 80e are transferred to the player into the credit meter 80a, upon which they become redeemable by the player at any time. The keno win meter 80e is then also reset to zero, and the keno status 72 resumes displaying the status of the keno game 70 and the time remaining until the subsequent execution of the keno game 70.

In FIG. 10 is shown an exemplary second pay table 78 for the second wagering game 70, or keno game 70. In the first column of the pay table 78, it is shown that in this embodiment, a player 76 is permitted to select between four and ten of the numbers for each play of the keno game 70, as seen by the ten numbers selected by the player 76 in FIG. 8. The awards paid to a player 76 depend upon the number of selections the player 76 made. The winning outcomes 79a of the keno game 70 are shown along the top of the pay table 78 and include between zero and ten matches. The corresponding keno payouts or credit awards 79b are shown in the body of the pay table 78 and correspond to both the number of selections made by the player 76 and the number of matches of those selections and the randomly selected outcome of the keno game 70.

Therefore, the keno bonus awards 98 when awarded in the poker game 60 do not have an actual credit value associated with them. Instead, the keno bonus awards 98 have only an expected value associated with an outcome of the “play” or “wager” of the keno bonus award 98 in the keno game 70. In other words, the keno bonus awards 98 comprise “bonus credits” which do not have any actual value until such bonus credits are wagered in the secondary keno game 70, such game 70 is completed, and such bonus wager is resolved. After the bonus wager is placed and resolved, any keno payouts 79b which are awarded in the keno game 70 become actual valuable credits which are transferred to the player's credit meter 80a where they may be redeemed. Thus, the actual value of the portion of the award comprising keno bonus credits is not known until the keno game 70 in which such bonus credits are wagered is completed, and such bonus wager is converted into a keno payout 79b, if any. Once completed, the resolution of the wagers favorably or unfavorably determines the actual value of the bonus credits wagered.

In the embodiments discussed herein, the first wagering game 70 is a traditional five card draw poker game 70 wherein the player is dealt an initial five card hand. The player is then permitted to hold or discard one or more of the dealt cards, and is dealt replacement cards for each of the discarded cards to form a modified five card hand. This modified five card hand is evaluated for winning outcomes 92 by comparing the outcome thereof to the pay table 90 of winning hands. However, in other embodiments, the first wagering game 70 may take on many other forms including a slot game, a cascading symbols game, a card game, a dice game, or any other game with a randomly selected outcome on which wagers may be placed.

In some embodiments, there may be one or more eligibility requirements for the player to be eligible to receive the variable portion of the award (e.g. keno bonus awards 98 on the pay table 90) in addition to the fixed portion of the award. For example, in one embodiment, a player wagering 1, 2, 3, or 4 credits on each play of the poker game 60 is not eligible for any keno bonus awards 98 in the pay table 90. Only a player who is wagering the maximum wager permissible on the gaming machine 10 (“max-betting”), which in the embodiments shown in the FIGURES is five credits, is eligible to win keno bonus credits 98 upon achieving selected winning outcomes 92. Other eligibility requirements may include minimum wager amounts, minimum play times, minimum number of games played, or other criteria.

Each of these embodiments and obvious variations thereof is contemplated as falling within the spirit and scope of the claimed invention, which is set forth in the following claims.

What is claimed is:

1. A gaming system comprising:
a wager input device;
a display for displaying a first randomly selected outcome of a first wagering game, the first randomly selected outcome selected from a first plurality of possible outcomes, the first plurality of possible outcomes including a first winning outcome; and
a controller operative to provide a first award to the player when the first randomly selected outcome is the first winning outcome, the first award comprising a fixed portion and a variable portion, the fixed portion having a predetermined value, the variable portion having an expected value for which the actual value is determined at least in part by a second randomly selected outcome of a second wagering game, wherein the second wagering game is triggered independently of the first wagering game.

2. The gaming system of claim 1, wherein the fixed portion comprises an amount of credits associated with the first winning outcome in a first pay table.

3. The gaming system of claim 2, wherein the variable portion comprises an amount of bonus credits associated with the first winning outcome in the first pay table, wherein the bonus credits are wagered in the second wagering game.

4. The gaming system of claim 3, wherein the second randomly selected outcome is selected from a second plurality of possible outcomes, the second plurality of possible outcomes including a second winning outcome.

5. The gaming system of claim 4, wherein in response to the second randomly selected outcome being the second winning outcome, the controller is further operative to award a second award.

6. The gaming system of claim 5, wherein the second award comprises a predetermined amount of credits associated with the second winning outcome in a second pay table.

7. The gaming system of claim 6, wherein the second award is redeemable by a player of the gaming system, wherein the bonus credits are not redeemable by the player.

8. The gaming system of claim 1, wherein the second wagering game is also displayed on the display.

9. The gaming system of claim 1, wherein the first wagering game is a poker game and the second wagering game is a keno game.

10. The gaming system of claim 1, wherein the first wagering game is an individual game and the second wagering game is a community game.

11. The gaming system of claim 1, wherein the display is supported by a housing of a handheld gaming device.

12. A method of conducting a wagering game on a gaming system, the method comprising:
receiving a wager from a player;
displaying a first randomly selected outcome of a first wagering game, the first randomly selected outcome selected from a first plurality of possible outcomes, the first plurality of possible outcomes including a first winning outcome;
in response to the first randomly selected outcome being the first winning outcome, awarding a first award to the player, the first award comprising a fixed portion and a variable portion, the fixed portion having a predetermined value, the variable portion having an expected value and comprising a wager input on a second wagering game;
wagering the variable portion on a second randomly selected outcome of the second wagering game;
triggering the second wagering game independently of the first wagering game; and
determining an actual value of the variable portion of the first award based at least in part upon the second randomly selected outcome.

13. The method of claim 12, wherein the variable portion comprises a predetermined number of bonus credits wagered in the second wagering game.

14. The method of claim 12, further comprising receiving a plurality of player selections in the second wagering game.

15. The method of claim 13, wherein the actual value is determined by resolving the wager of the bonus credits based upon a pay table for the second wagering game.

16. The method of claim 13, wherein the actual value is based upon a number of matches between the plurality of player selections and the second randomly selected outcome.

17. The method of claim 12, wherein the first wagering game is poker.

18. The method of claim 17, wherein the first winning outcome includes a jack.

19. A method of conducting a wagering game on a gaming system, the method comprising:
receiving a wager from a player;
displaying a randomly selected outcome of the wagering game, the randomly selected outcome selected from a plurality of possible outcomes, the plurality of possible outcomes including a plurality of winning outcomes;
in response to the randomly selected outcome being a first winning outcome, providing a first predetermined credit award to the player;
in response to the randomly selected outcome being a second winning outcome, providing a composite award to the player, the composite award comprising a second predetermined credit award and a variable award, the variable award represented by a predetermined number of bonus credits, the variable award having an expected value and an actual value, wherein the actual value is determined by wagering the bonus credits in an independently conducted second wagering game.

20. The method of claim 19, wherein the second wagering game is conducted after the displaying step.

21. The method of claim 19, wherein the first wagering game is poker, wherein the second winning outcome includes at least one of a card having a predetermined rank or a predetermined suit, or both.

22. The method of claim 21, wherein the first winning outcome does not include the card.

23. The method of claim 22, wherein the second wagering game is a community keno game.

24. A computer readable storage medium encoded with instructions for directing a gaming system to perform the method of claim 12.
